(19) United States
(12) Patent Application Publication
(10) Pub. No.: US 2025/0224576 A1
(43) Pub. Date: Jul. 10, 2025

(54) OPTICAL MODULE

(71) Applicant: HISENSE BROADBAND MULTIMEDIA TECHNOLOGIES CO., LTD., Qingdao (CN)

(72) Inventors: Qian SHAO, Qingdao (CN); Weiwei LIU, Qingdao (CN); Baoquan LENG, Qingdao (CN)

(21) Appl. No.: 19/094,515

(22) Filed: Mar. 28, 2025

Related U.S. Application Data
(63) Continuation of application No. PCT/CN2022/141871, filed on Dec. 26, 2022.

(30) Foreign Application Priority Data
Sep. 29, 2022 (CN) 202211203983.X

(51) Int. Cl. G02B 6/42; H04B 10/40

(52) U.S. Cl. CPC G02B 6/4246; G02B 6/4243; H04B 10/40

(57) ABSTRACT

The present disclosure provides an optical module including a circuit board and an optical transceiver assembly. The circuit board is provided with a hollowed-out area. The optical transceiver assembly includes a transceiver base and an optical assembly. The transceiver base includes a base body and a first support protrusion, and the base body is also provided thereon with a second support protrusion and a storage groove. The first support protrusion, the second support protrusion and the storage groove are all engaged with the hollowed-out area. The optical assembly includes a laser chip and a lithium niobate chip. The laser chip is located at a first end of the first support protrusion, and the lithium niobate chip is located at a second end of the first support protrusion. The laser chip is located in the storage groove, and the lithium niobate chip is located on the first support protrusion.

This disclosure is a continuation of PCT/CN2022/141871 filed on Dec. 26, 2022, which claims priority to application No. 202211203983.X filed on Sep. 29, 2022 with the China National Intellectual Property Administration (CNIPA), the entire disclosures of which are incorporated herein by reference.

### FIELD OF THE INVENTION

The present disclosure relates to the field of optical communication technology, and in particular, to an optical module.

### BACKGROUND OF THE INVENTION

The industry has raised higher requirements for the optical power emitted by the optical module.

### SUMMARY OF THE INVENTION

The present disclosure provides an optical module, which includes: a circuit board having a hollowed-out area; and an optical transceiver assembly including a transceiver base and an optical assembly. The transceiver base includes a base body and a first support protrusion protruded by the base body; the base body is provided with a storage groove and a second support protrusion. The first support protrusion, the second support protrusion and the storage groove are all engaged in the hollowed-out area. The optical assembly includes a laser chip and a lithium niobate chip, wherein the laser chip is located at a first end of the first support protrusion, and the lithium niobate chip is located at a second end of the first support protrusion; the laser chip is located in the storage groove, and the lithium niobate chip is located on the second support protrusion.

### BRIEF DESCRIPTION OF THE DRAWINGS

The accompanying drawings to be used in some embodiments of the present disclosure will be described briefly below so as to more clearly describe the technical solutions of the present disclosure. Apparently, the accompanying drawings described below are only those of some embodiments of the present disclosure, and for those skilled in the art, other drawings may also be derived from these accompanying drawings. In addition, the accompanying drawings as described below may be regarded as schematic diagrams and are not intended to limit the actual size of the product, the actual process of the method, or the actual timing of the signal involved in the disclosed embodiments.

FIG. 1 is a connection relationship diagram of an optical communication system according to some embodiments of the present disclosure;

FIG. 2 is a structural diagram of an optical network unit according to some embodiments of the present disclosure;

FIG. 3 is a structural diagram of an optical module according to some embodiments of the present disclosure;

FIG. 4 is an exploded structural view of an optical module according to some embodiments of the present disclosure;

FIG. 5 is a structural diagram of an optical module without an upper shell part according to some embodiments;

FIG. 6 is a structural diagram of an optical fiber adapter, an optical fiber ferrule, an optical transceiver assembly and a circuit board according to some embodiments;

FIG. 7 is an exploded view of an optical fiber adapter, an optical fiber ferrule, an optical transceiver assembly and a circuit board according to some embodiments;

FIG. 8 is a first structural diagram of an internal optical fiber, an optical fiber ferrule, an optical transceiver assembly and a circuit board according to some embodiments;

FIG. 9 is a second structural diagram of an internal optical fiber, an optical fiber ferrule, an optical transceiver assembly and a circuit board according to some embodiments;

FIG. 10 is a third structural diagram of an internal optical fiber, an optical fiber ferrule, an optical transceiver assembly and a circuit board according to some embodiments;

FIG. 11 is a first sectional view of an internal optical fiber, an optical fiber ferrule, an optical transceiver assembly and a circuit board according to some embodiments;

FIG. 12 is a second sectional view of an internal optical fiber, an optical fiber ferrule, an optical transceiver assembly and a circuit board according to some embodiments;

FIG. 13 is an exploded view of an optical fiber ferrule, an optical transceiver assembly and a circuit board according to some embodiments;

FIG. 14 is a first structural diagram of an optical assembly according to some embodiments;

FIG. 15 is a second structural diagram of an optical assembly according to some embodiments;

FIG. 16 is a first structural diagram of an upper cover according to some embodiments;

FIG. 17 is a second structural diagram of an upper cover according to some embodiments;

FIG. 18 is a structural diagram of a circuit board according to some embodiments;

FIG. 19 is a first structural diagram of a transceiver base according to some embodiments;

FIG. 20 is a second structural diagram of a transceiver base according to some embodiments;

FIG. 21 is a first sectional view of a transceiver base and a circuit board according to some embodiments;

FIG. 22 is a second sectional view of a transceiver base and a circuit board according to some embodiments;

FIG. 23 is a third sectional view of a transceiver base and a circuit board according to some embodiments; and

FIG. 24 is a diagram showing an optical path of an optical module according to some embodiments.

### DETAILED DESCRIPTION OF THE EMBODIMENTS

Technical solutions of some embodiments of this disclosure will be described clearly and in detail with reference to the accompanying drawings below. Obviously, these embodiments are merely some, but not all, of the embodiments of this disclosure. All other embodiments obtained by those skilled in the art based on the embodiments of this disclosure fall within the protection scope of this disclosure.

The term “comprise” and other forms thereof such as the third-person singular form “comprises” and the present participle form “comprising” should be construed as open and inclusive, i.e., “including, but not limited to”, throughout the description and the claims unless the context indicates otherwise, In the description, terms such as “one embodiment”, “some embodiments”, “exemplary embodiments”, “example”, “specific example” or “some examples” are intended to indicate that specific features, structures, materials or characteristics related to the embodiment(s) or example(s) are included in at least one embodiment or example of the present disclosure. Schematic representations of the above terms do not necessarily refer to the same embodiment(s) or example(s). In addition, the specific features, structures, materials or characteristics may be included in any one or more embodiments or examples in any suitable manner.

Hereinafter, the terms “first” and “second” are used for descriptive purposes only, and are not to be construed as indicating or implying the relative importance or implicitly indicating the number of indicated technical features. Thus, features defined as “first” and “second” may explicitly or implicitly include one or more of the features. In the description of the embodiments of the present disclosure, the term “a plurality of” means two or more.

In the description of some embodiments, the terms “coupled” and “connected” and their extensions may be used. For example, the term “connected” may be used in the description of some embodiments to indicate that two or more components are in direct or indirect physical or electrical contact with each other. For another example, the term “coupled” may be used in the description of some embodiments to indicate that two or more components are in direct or indirect physical or electrical contact. However, the term “coupled” or “communicatively coupled” may also mean that two or more components are not in direct contact with each other, but still cooperate or interact with each other. The embodiments disclosed herein are not necessarily limited to the contents herein.

The phrase “at least one of A, B and C” has the same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

The use of the phrase “configured to” herein means an open and inclusive language, which does not exclude devices that are configured to perform additional tasks or steps.

The term “about”, “substantially” or “approximately” as used herein includes a stated value and an average value within an acceptable range of deviation of a particular value determined by a person of ordinary skill in the art, considering measurement in question and errors associated with measurement of a particular quantity (i.e., limitations of a measurement system).

In optical communication technology, a light is employed to carry information to be transmitted, and the optical signal carrying the information is transmitted to an information processing device such as a computer through an information transmission device such as an optical fiber or an optical waveguide to complete transmission of the information. Since the optical signal has a characteristic of passive transmission when being transmitted through the optical fiber or the optical waveguide, low-cost and low-loss information transmission may be achieved. In addition, a signal transmitted by the information transmission device such as the optical fiber or the optical waveguide is an optical signal, while a signal that can be recognized and processed by the information processing device such as the computer is an electrical signal. Therefore, in order to establish information connection between the information transmission device, such as the optical fiber or the optical waveguide, and the information processing device such as the computer, it is necessary to achieve interconversion between the electrical signal and the optical signal.

An optical module is provided to perform interconversion between the optical signal and the electrical signal in the field of optical communication technology. The optical module includes an optical port and an electrical port. Optical communication between the optical module and the information transmission device, such as the optical fiber or the optical waveguide, is achieved through the optical port. Electrical connection between the optical module and an optical network unit (e.g., an optical modem) is achieved through the electrical port. The electrical connection is mainly to achieve power supply, transmission of an I2C signal, transmission of a data information, grounding and the like. The optical network unit transmits the electrical signal to the information processing device such as the computer through a network cable or wireless fidelity technology (Wi-Fi).

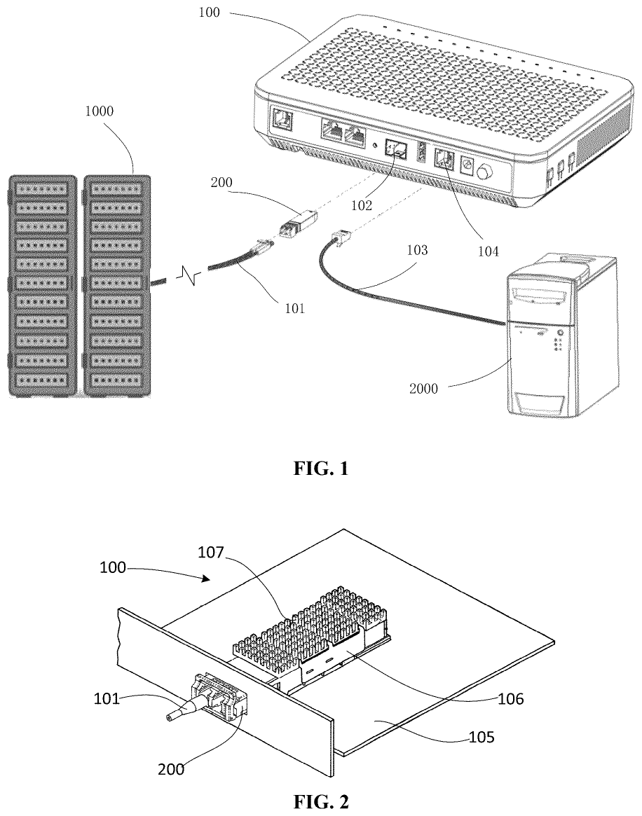

FIG. 1 is a diagram showing a connection relationship of an optical communication system according to some embodiments of the present application. As shown in FIG. 1, the optical communication system includes a remote server 1000, a local information processing device 2000, an optical network unit 100, an optical module 200, an optical fiber 101 and a network cable 103.

One end of the optical fiber 101 is connected to the remote server 1000, and the other end is connected to the optical network unit 100 through the optical module 200. The optical fiber itself may support long-distance signal transmission, such as several-kilometer (6 kilometers to 8 kilometers) signal transmission. Based on this, if a repeater is used, infinite-distance transmission may be achieved theoretically. Therefore, in a typical optical communication system, a distance between the remote server 1000 and the optical network unit 100 may typically be several kilometers, tens of kilometers, or hundreds of kilometers.

One end of the network cable 103 is connected to the local information processing device 2000, and the other end is connected to the optical network unit 100. The local information processing device 2000 may be at least one of the followings: a router, a switch, a computer, a mobile phone, a tablet computer, a television or the like.

A physical distance between the remote server 1000 and the optical network unit 100 is greater than a physical distance between the local information processing device 2000 and the optical network unit 100. Connection between the local information processing device 2000 and the remote server 1000 is completed by the optical fiber 101 and the network cable 103, and connection between the optical fiber 101 and the network cable 103 is completed by the optical module 200 and the optical network unit 100.

The optical module 200 includes the optical port and the electrical port. The optical port is configured to be connected with the optical fiber 101, such that a bidirectional optical signal connection is established between the optical module 200 and the optical fiber 101. The electrical port is configured to be coupled with the optical network unit 100, such that a bidirectional electrical signal connection is established between the optical module 200 and the optical network unit 100. Interconversion between the optical signal and the electrical signal is achieved by the optical module 200, such that information connection between the optical fiber 101 and the optical network unit 100 is established. For example, an optical signal from the optical fiber 101 is converted into an electrical signal by the optical module 200, and then the electrical signal is input into the optical network unit 100; an electrical signal from the optical network unit 100 is converted into an optical signal by the optical module 200, and then the optical signal is input into the optical fiber 101. Since the optical module 200 is a tool for realizing mutual conversion between the optical signal and the electrical signal, and does not have a function of processing the data, the information does not change in the above-mentioned photoelectric conversion process.

The optical network unit 100 includes a housing which is substantially in a cuboid shape, and an optical module interface 102 and a network cable interface 104 that are disposed on the housing. The optical module interface 102 is configured to access the optical module 200, such that a bidirectional electrical signal connection is established between the optical network unit 100 and the optical module 200. The network cable interface 104 is configured to access the network cable 103, such that a bidirectional electrical signal connection is established between the optical network unit 100 and the network cable 103. Connection between the optical module 200 and the network cable 103 is established through the optical network unit 100. For example, the optical network unit 100 transmits an electrical signal from the optical module 200 to the network cable 103, and transmits an electrical signal from the network cable 103 to the optical module 200. Therefore, the optical network unit 100, as a host computer of the optical module 200, may monitor operation of the optical module 200. In addition to the optical network unit 100, the host computer of the optical module 200 may further include an optical line terminal (OLT).

A bidirectional signal transmission channel is established between the remote server 1000 and the local information processing device 2000 through the optical fiber 101, the optical module 200, the optical network unit 100 and the network cable 103.

FIG. 2 is a structural diagram of an optical network unit according to some embodiments of this application. As shown in FIG. 2, FIG. 2 only shows structures of the optical network unit 100 that are related to the optical module 200 so as to clearly show a connection relationship between the optical module 200 and the optical network unit 100. As shown in FIG. 2, the optical network unit 100 includes a circuit board 105 disposed in the housing, a cage 106 disposed on a surface of the circuit board 105, a heat sink 107 disposed on the cage 106 and an electrical connector disposed inside the cage 106. The electrical connector is configured to access the electrical port of the optical module 200; the heat sink 107 has protruding structures such as fins for increasing a heat dissipation area.

The optical module 200 is inserted into the cage 106 of the optical network unit 100, the optical module 200 is fixed by the cage 106, and heat generated by the optical module 200 is conducted to the cage 106 and is dissipated through the heat sink 107. After the optical module 200 is inserted into the cage 106, the electrical port of the optical module 200 is connected to the electrical connector in the cage 106, and thus the bidirectional electrical signal connection is established between the optical module 200 and the optical network unit 100. In addition, the optical port of the optical module 200 is connected to the optical fiber 101, such that the bidirectional optical signal connection is established between the optical module 200 and the optical fiber 101.

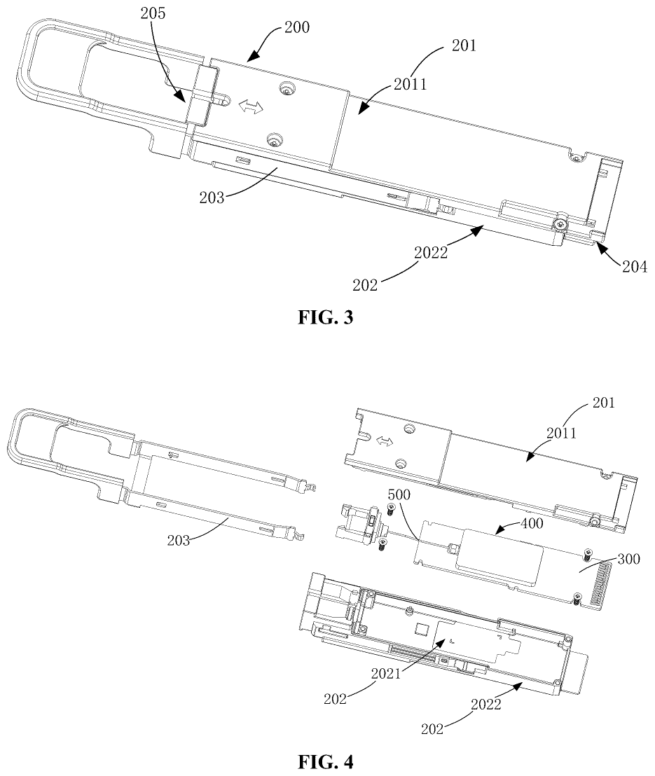

FIG. 3 is a structural diagram of an optical module according to some embodiments of the present disclosure, and FIG. 4 is an exploded structural diagram of an optical module according to some embodiments of the present disclosure. As shown in FIGS. 3 and 4, the optical module 200 includes a shell, a circuit board 300 disposed in the shell and an optical transceiver assembly 400.

The shell includes a lower shell part 202 and an upper shell part 201 covers on the lower shell part 202 to form the shell with two openings. An outer contour of the shell may be in a cuboid shape.

In some embodiments of this disclosure, the lower shell part 202 includes a bottom plate 2021 and two lower side plates 2022 located on opposite sides of the bottom plate 2021 and disposed perpendicular to the bottom plate 2021; the upper shell part 201 includes a cover plate 2011 covers on the two lower side plates 2022 of the lower shell part 202 to form the above mentioned shell.

In some embodiments, the lower shell part 202 includes a bottom plate 2021 and two lower side plates 2022 located on both sides of the bottom plate 2021 and disposed perpendicular to the bottom plate 2021; the upper shell part 201 include a cover plate 2011 and two upper side plates located on both sides of the cover plate 2011 and disposed perpendicular to the cover plate 2011, and the two upper side plates are combined with the two lower side plates 2022, such that the upper shell part 201 covers the lower shell part 202.

A direction of a connecting line between the two openings 204 and 205 may be the same as a length direction of the optical module 200, or may not be the same as the length direction of the optical module 200. For example, the opening 204 is located at an end (a right end in FIG. 3) of the optical module 200, and the opening 205 is also located at an end (a left end in FIG. 3) of the optical module 200. Alternatively, the opening 204 is located at an end of the optical module 200, and the opening 205 is located at a side of the optical module 200. The opening 204 is the electrical port, and a golden finger 301 of the circuit board 300 extends from the electrical port 204, and is inserted into the host computer (e.g., the optical network unit 100); the opening 205 is the optical port, which is configured to access the external optical fiber 101, such that the optical fiber 101 is connected to optical transceiver assembly 400 in the optical module 200.

By using an assembly mode of combining the upper shell part 201 with the lower shell part 202, it facilitates installation of the circuit board 30, the optical transceiver assembly 400 and other components into the shell, and the upper shell part 201 and the lower shell part 202 may form encapsulation and protection for these components. In addition, it facilitates to arrange positioning components, heat dissipation components and electromagnetic shielding components of these devices when assembling the circuit board 300, the optical transceiver assembly 400 and other components, which is conducive to implementation of automated production.

In some embodiments, the upper shell part 201 and the lower shell part 202 are generally made of a metallic material, which facilitates electromagnetic shielding and heat dissipation.

In some embodiments, the optical module 200 further includes an unlocking component located outside of the shell thereof, and the unlocking component is configured to achieve or release a fixed connection between the optical module 200 and the host computer.

For example, the unlocking component is located on outer walls of the two lower side plates 2022 of the lower shell part 202, and includes an engagement component that is matched with the cage of the host computer (e.g., the cage 106 of the optical network unit 100). When the optical module 200 is inserted into the cage of the host computer, the optical module 200 is fixed in the cage of the host computer via the engagement component of the unlocking component.

When the unlocking component is pulled, the engagement component of the unlocking component moves therewith, which in turn changes a connection relationship between the engagement component and the host computer to release engagement between the optical module 200 and the host computer, such that the optical module 200 may be drawn out of the cage of the host computer.

The circuit board 300 includes circuit wires, electronic elements, chips and the like. The electronic elements and the chips are connected together through the circuit wires according to a circuit design, so as to achieve functions of power supply, electrical signal transmission, grounding and the like. The electronic elements may include, for example, capacitors, resistors, triodes, and metal-oxide-semiconductor field-effect transistors (MOSFETs). The chips may include, for example, a microcontroller unit (MCU), a laser driver chip, a limiting amplifier (LA), a clock and data recovery (CDR) chip, a power management chip and a digital signal processing (DSP) chip.

The circuit board 300 is generally a rigid circuit board which may further achieve a load-bearing function due to its hard material. For example, the rigid circuit board may stably bear the above mentioned electronic elements and the chips. The rigid circuit board may also stably carry the optical transceiver assembly 400 when it is located on the circuit board. The rigid circuit board may also be inserted into the electrical connector in the cage of the host computer.

The circuit board 300 also includes a golden finger 302 formed on a surface of an end thereof. The golden finger 301 is composed of a plurality of independent pins. The circuit board 300 is inserted into the cage 106 and is conductively connected to the electrical connector in the cage 106 through the golden finger 301. The golden finger 301 may be disposed only on a surface of one side (e.g., the upper surface as shown in FIG. 4) of the circuit board 300, or be disposed on surfaces of both upper and lower sides of the circuit board 300 to adapt to occasions where a large number of pins are required. The golden finger 301 is configured to establish electrical connection with the host computer to achieve power supply, grounding, transmission of an I2C signal, transmission of a data signal, etc.

Of course, some optical modules also use flexible circuit boards. The flexible circuit board, as a supplement to the rigid circuit board, is generally used in conjunction with the rigid circuit board. For example, a flexible circuit board may be used to connect a rigid circuit board with an optical transceiver assembly.

The optical transceiver assembly 400 is configured to emit and receive an optical signal.

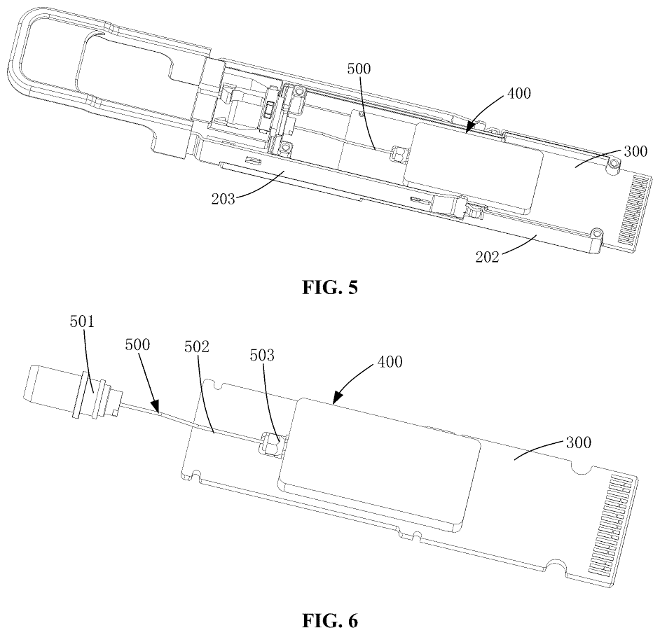

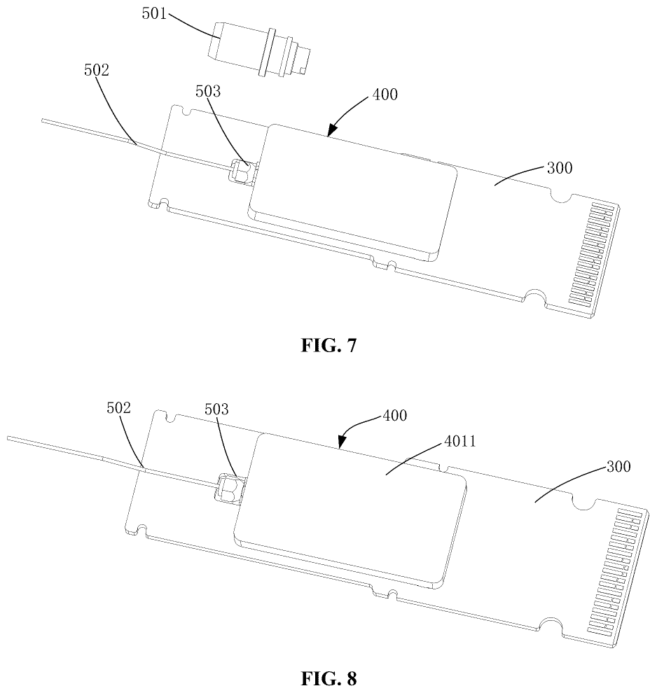

FIG. 5 is a structural diagram of an optical module without an upper shell part according to some embodiments, FIG. 6 is a structural diagram of an optical fiber ferrule assembly, an optical transceiver assembly and a circuit board according to some embodiments, and FIG. 7 is an exploded diagram of an optical fiber ferrule assembly, an optical transceiver assembly and a circuit board according to some embodiments. As shown in FIG. 5 to FIG. 7, in some embodiments, the optical module includes an optical fiber ferrule assembly 500 in addition to an upper shell part 201, a lower shell part 202, a circuit board 300, and an optical transceiver assembly 400.

The optical fiber ferrule assembly 500 includes an optical fiber adapter 501, an internal optical fiber 502 and an optical fiber ferrule 503. A first end of the optical fiber adapter 501 is connected to an external optical fiber, and a second end of the optical fiber adapter 501 is connected to a first end of an internal optical fiber. The optical fiber ferrule 503 is formed therein with an accommodation cavity, and a second end of the internal optical fiber 502 is inserted into the accommodation cavity of the optical fiber ferrule 503 through the first end of the optical fiber ferrule 503, and the second end of the optical fiber ferrule 503 is inserted into the optical transceiver assembly 400.

The optical fiber adapter 501 is an LC adapter, and the optical fiber ferrule 503 is an LC optical fiber ferrule. The LC adapter is configured to transmit an optical signal of the external optical fiber to the internal optical fiber 502, and is also configured to transmit the optical signal emitted by the optical module to the external optical fiber through the internal optical fiber 502.

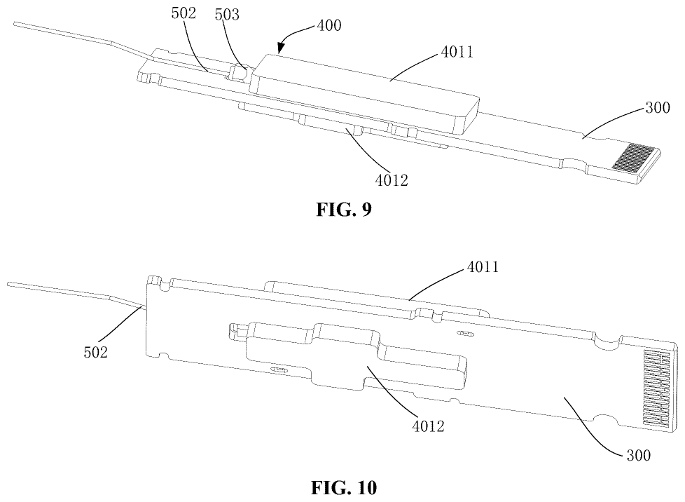

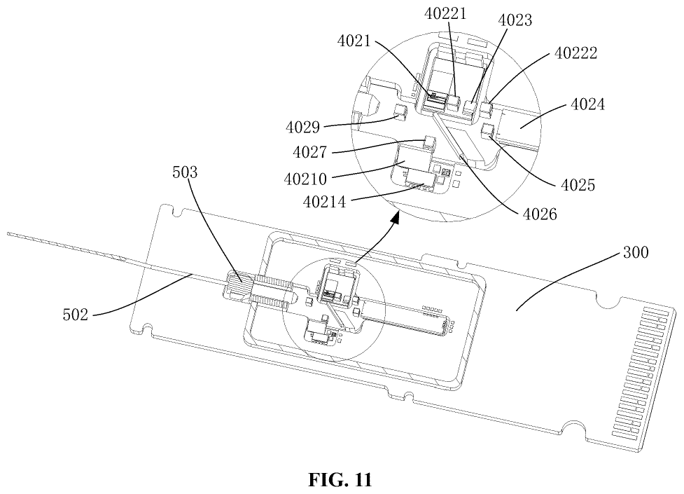

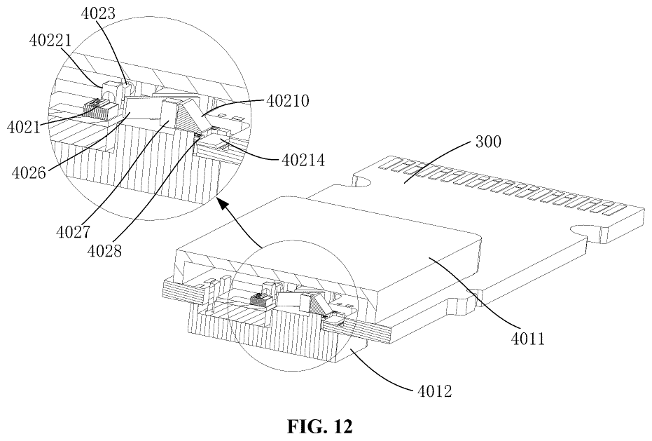

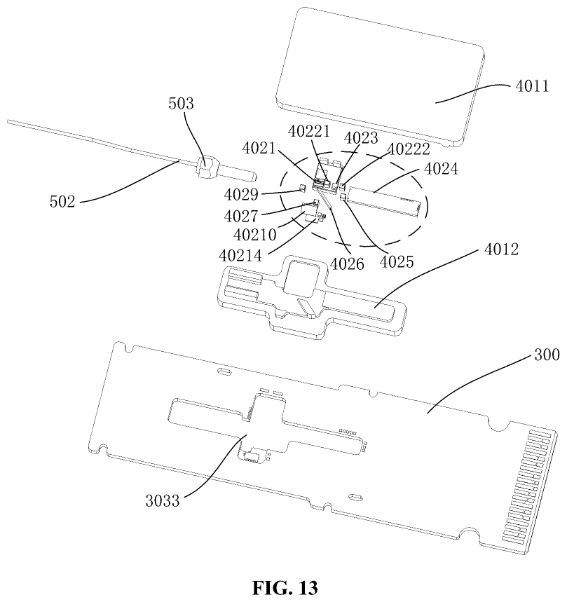

FIG. 8 is a first structural diagram of an internal optical fiber, an optical fiber ferrule, an optical transceiver assembly and a circuit board according to some embodiments. FIG. 9 is a second structural diagram of an internal optical fiber, an optical fiber ferrule, an optical transceiver assembly and a circuit board according to some embodiments. FIG. 10 is a third structural diagram of an internal optical fiber, an optical fiber ferrule, an optical transceiver assembly and a circuit board according to some embodiments. FIG. 11 is a first sectional diagram of an internal optical fiber, an optical fiber ferrule, an optical transceiver assembly and a circuit board according to some embodiments. FIG. 12 is a second sectional diagram of an internal optical fiber, an optical fiber ferrule, an optical transceiver assembly and a circuit board according to some embodiments. FIG. 13 is an exploded diagram of an optical fiber ferrule, an optical transceiver assembly and a circuit board according to some embodiments. As shown in FIGS. 5 to 13, in some embodiments, the optical transceiver assembly 400 includes an upper cover 4011, a transceiver base 4012, and an optical assembly. The circuit board 300 is provided with a hollowed-out area 3033 which is arranged corresponding to the upper cover 4011 and the transceiver base 4012. The upper cover 4011 is covered on the circuit board 300, and the transceiver base 4012 is fitted within the hollowed-out area 3033, such that the upper cover 4011 and the transceiver base 4012 form a transceiver cavity having an insertion hole, and the optical assembly is located in the transceiver cavity. The optical fiber ferrule 503 is inserted into the optical transceiver assembly 400 through the insertion hole.

As shown in FIGS. 5 to 13, in some embodiments, the optical fiber ferrule 503 is located in the hollowed-out area 3033, and the optical fiber ferrule 503 is coupled to the transceiver base 4012. Since the first end of the optical fiber ferrule 503 is wrapped with a sleeve base, a height of the first end of the optical fiber ferrule 503 is greater than a height of the second end of the optical fiber ferrule 503. Since the height of the first end of the optical fiber ferrule 503 is greater than the height of the second end of the optical fiber ferrule 503, if the first end of the optical fiber ferrule 503 is engaged at the insertion hole formed by the transceiver base 4012 and the upper cover, the second end of the optical fiber ferrule 503 may not be engaged at the insertion hole formed by the transceiver base 4012 and the upper cover. To avoid this situation, in some embodiments, the first end of the optical fiber ferrule 503 is no longer engaged at the insertion hole formed by the transceiver base 4012 and the upper cover, but is directly engaged in the hollowed-out area 3033, and a length of the hollowed-out area 3033 is greater than those of the upper cover 4011 and the transceiver base 4012.

In order to protect most of the optical assemblies located in the hollowed-out area 3033 and a small portion of the optical assemblies located on the circuit board 300, in some embodiments, a width of the upper cover 4011 is greater than a width of the hollowed-out area 3033. The upper cover 4011 is configured to protect the optical assembly to prevent the optical assembly from being impacted or contaminated, which otherwise would affect the optical path.

In order to avoid a situation where a region of the hollowed-out area 3033 other than the region where the optical fiber ferrule 503 is placed cannot be sealed and connected to the transceiver base 4012, in some embodiments, a width of the transceiver base 4012 is greater than a width of the hollowed-out area 3033.

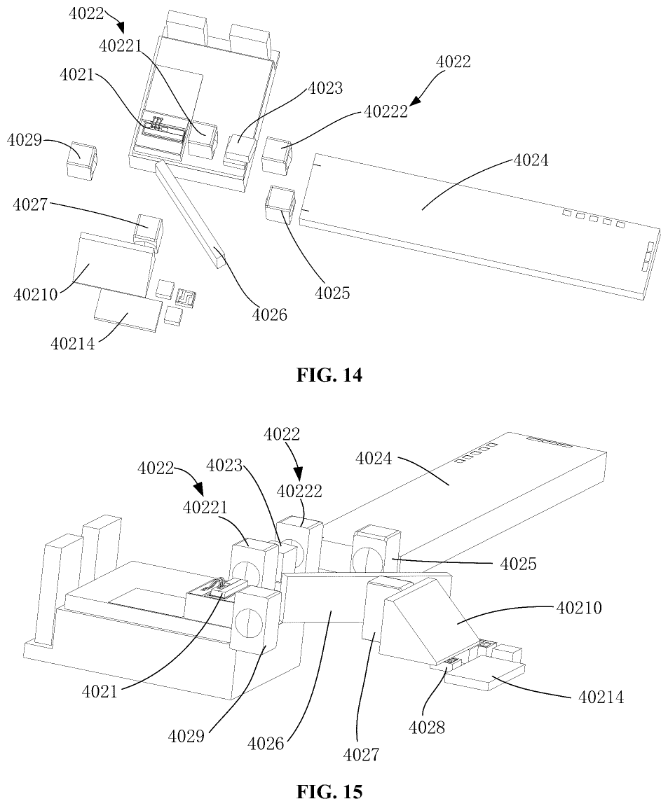

FIG. 14 is a first structural diagram of an optical assembly according to some embodiments. FIG. 15 is a second structural diagram of an optical assembly according to some embodiments. As shown in FIGS. 13 to 15, in some embodiments, the optical assembly includes a laser chip 4021, a first lens 4022, an isolator 4023, a lithium niobate chip 4024, a second lens 4025, a first filter 4026, a third lens 4027, a fourth lens 4029, a receiving and turning prism 40210, an optical reception chip 4028, and a transimpedance amplifier chip 40214. The laser chip 4021, the first lens 4022, the isolator 4023, the lithium niobate chip 4024, the second lens 4025, the first filter 4026, the third lens 4027 and the receiving and turning prism 40210 are all located on the transceiver base 4012; and the optical reception chip 4028 and the transimpedance amplifier chip 40214 are located on the circuit board 300. In some embodiments of the present disclosure, the laser chip 4021 is configured to emit high-power light. In some embodiments of the present disclosure, since the laser chip 4021 is a high-power DFB laser chip, the laser chip 4021 can provide high-power light. The wavelength of the high-power light emitted by the laser chip 4021 is λ1, and the high-power light emitted by the laser chip 4021 is divergent light.

Since the high-power light emitted by the laser chip 4021 is divergent light, in order to couple the divergent light emitted by the laser chip 4021 to the lithium niobate chip 4024, the first lens 4022 is disposed between the laser chip 4021 and the lithium niobate chip 4024.

The first lens 4022 is located between the laser chip 4021 and the lithium niobate chip 4024, and is configured to couple the high-power light emitted by the laser chip 4021 into the lithium niobate chip 4024. In some embodiments of the present disclosure, the first lens 4022 is a focusing lens, which couples the divergent light into the lithium niobate chip 4024.

In addition to being a focusing lens, the first lens 4022 may include a collimating lens and a focusing lens. In the case that the first lens 4022 includes a collimating lens and a focusing lens, the first lens 4022 includes a first sub-lens 40221 and a second sub-lens 40222, wherein the first sub-lens 40221 is a collimating lens, and the second sub-lens 40222 is a focusing lens. As shown in FIGS. 13 to 15, firstly, the first sub-lens 40221 collimates the divergent light to obtain a collimated light, then the second sub-lens 40222 focuses the collimated light and couples it into the lithium niobate chip 4024.

Since the light coupled to the lithium niobate chip 4024 via the first lens 4022 may return along its original path, damaging the laser chip 4021, an isolator 4023 is disposed between the laser chip 4021 and the lithium niobate chip 4024 so as to prevent the light coupled to the lithium niobate chip 4024 through the first lens 4022 from returning along its original path.

The isolator 4023 is configured to prevent the light coupled into the lithium niobate chip 4024 through the first lens 4022 from returning along the original path.

When the first lens 4022 is a focusing lens, the isolator 4023 is located between the first lens 4022 and the lithium niobate chip 4024; when the first lens 4022 includes a collimating lens and a focusing lens, the isolator 4023 is located between the first sub-lens 40221 and the second sub-lens 40222.

The requirement on the optical power of the light emitted by the optical module is higher. In order to solve this problem, in some embodiments, it is proposed that the optical module includes a combination of a laser chip and a lithium niobate chip.

The lithium niobate chip 4024 includes a substrate and a lithium niobate film, the substrate is a glass substrate, and the lithium niobate film is laid on the substrate. The thickness of the lithium niobate film is less than 100 μm. Since the lithium niobate chip is relatively small and has a relatively high integration accuracy, it has such advantages as low power consumption and low optical loss, compared with the silicon photonic chip. Among them, the optical loss of the silicon photonic chip is less than 11.2 dB, while the optical loss of the lithium niobate chip is less than 10 dB.

A thickness of the lithium niobate film is less than 100 μm. In order to further reduce the size of the lithium niobate chip, in some embodiments, the thickness of the lithium niobate film is less than 20 μm. To further reduce the size of the lithium niobate chip, the thickness of the lithium niobate film is less than 100 μm.

Since the optical loss of silicon photonic chips is less than 11.2 dB, in order for an optical module including the combination of the laser chip and the silicon photonic chip to meet a requirement of the optical power of the light emitted by 50 G PON, it is required that the optical power of the light emitted by the DFB laser chip is greater than 158 mW. Since the optical loss of lithium niobate chips is less than 10 dB, in order for the optical module including a combination of the DFB laser chip and the lithium niobate chip to meet the optical power requirement of the light emitted by 50 G PON, it is required that the optical power of the light emitted by the DFB laser chip is greater than 80 mW.

The lithium niobate chip 4024 is configured to modulate high-power light. In some embodiments of the present disclosure, on one side of the lithium niobate chip 4024 is provided with an input port and an output port. An input optical waveguide, an MZ modulator and an output optical waveguide are provided in the lithium niobate chip 4024. The input optical waveguide connects the input port with an input end of the MZM modulator, and the output optical waveguide connects an output end of the MZM modulator with the output port. The high-power light is incident into the input optical waveguide of the lithium niobate chip 4024 through the input port. Most of the high-power light received by the input optical waveguide is incident into the input end of the MZM modulator; the MZ modulator modulates the high-power light to obtain a modulated optical signal; the modulated optical signal is output to the output optical waveguide through the output end of the MZM modulator. Most of the modulated optical signals received by the output optical waveguide are output through the output port. Among them, the modulated optical signal is a divergent optical signal.

The input port and the output port of the lithium niobate chip 4024 may also be arranged on different sides of the lithium niobate chip 4024. However, if the input port and the output port of the lithium niobate chip 4024 are arranged on different sides of the lithium niobate chip 4024, the length of the lithium niobate chip 4024 may be increased, thereby increasing a length of an optical module in which the lithium niobate chip 4024 is packaged. Therefore, in order to reduce the length of the lithium niobate chip 4024, in some embodiments, the input port and the output port may be arranged on one side of the lithium niobate chip 4024.

A first power monitor and a second power monitor are disposed on a surface of the lithium niobate chip 4024. The first power monitor is located near the input optical waveguide of the lithium niobate chip 4024, and the second power monitor is located near the output optical waveguide of the lithium niobate chip 4024. The first power monitor is configured to monitor a small portion of light received by the input optical waveguide to monitor the optical power, and the second power monitor is configured to monitor a small portion of the optical signal received by the output optical waveguide to monitor whether the MZM modulator is at the optimal modulation point.

The lithium niobate chip may modulate high-power light (optical power emitted by the laser chip is larger than 80 mW). Optical loss of the lithium niobate thin film modulator (which is less than 10 dB) is less than that of the silicon photonic chip (which is less than 11.2 dB), thus the modulated optical signal can meet the optical power of light emitted by 50 G PON.

The second lens 4025 is located between the lithium niobate chip 4024 and the first filter 4026, and is configured to collimate the optical signal output by the lithium niobate chip 4024. In some embodiments of the present disclosure, since the optical signal output by the lithium niobate chip 4024 is a divergent optical signal, the second lens 4025 is a collimating lens, which collimates the divergent optical signal output by the lithium niobate chip 4024 to obtain a collimated optical signal.

The first filter 4026 is configured to transmit an optical signal of certain wavelength and reflect a second optical signal to the third lens 4027. In some embodiments of the present disclosure, the first filter 4026 is configured to transmit an optical signal of a wavelength λ1 and reflect a second optical signal to the third lens 4027. Wherein, an optical signal emitted from a transceiver housing is a first optical signal, and an optical signal incident into the transceiver housing is the second optical signal.

The first filter 4026 may include two 45-degree triangular prisms, hypotenuses of the two 45-degree triangular prisms are bonded to each other, with one of the hypotenuses being coated with a filter film; alternatively, the first filter may include a glass sheet, wherein the end of the glass sheet facing the internal optical fiber is coated with a filter film. The design of the first filter 4026 including two 45-degree triangular prisms is convenient for production process and operation. In a case that the first filter 4026 includes a glass sheet, a filter bracket is provided to fix the glass sheet on the transceiver base.

The first filter 4026 includes a glass sheet, as shown in FIGS. 13 to 15.

The fourth lens 4029 is located between the optical fiber ferrule assembly 500 and the first filter 4026. The fourth lens 4029 is configured to couple the optical signal transmitted through the first filter 4026 to the optical fiber ferrule 503 of the optical fiber ferrule assembly 500, and to collimate the second optical signal from the optical fiber ferrule 503 of the optical fiber ferrule assembly 500 into the first filter 4026.

The third lens 4027 is located between the first filter 4026 and the receiving and turning prism 40210, and is configured to couple the second optical signal reflected by the first filter 4026 to the receiving and turning prism 40210. In some embodiments of the present disclosure, the third lens 4027 is a focusing lens, which couples the second optical signal reflected by the first filter 4026 to the receiving and turning prism 40210.

The receiving and turning prism 40210 is configured to change the direction of the second optical signal such that the optical reception chip 4028 receives the second optical signal. In some embodiments of the present disclosure, since the photosensitive surface of the optical reception chip 4028 is vertically arranged relative to the third lens 4027, if there is no receiving and turning prism 40210, the optical reception chip 4028 cannot receive the second optical signal. The receiving and turning prism 40210 is located above the optical reception chip 4028. The receiving and turning prism 40210 is configured to change the direction of the second optical signal coupled by the fourth lens 4029 such that the optical reception chip 4028 receives the second optical signal.

In order to enable the optical reception chip 4028 to receive as much of the second optical signal as possible, in some embodiments, the receiving and turning prism 40210 is disposed at the focus of the optical reception chip 4028.

An angle of the receiving and turning prism 40210 is 41° to 43°. In some embodiments of the present disclosure, the angle of the receiving and turning prism 40210 cannot be set to 45° to avoid the second optical signal vertically incident on the optical reception chip and reduce reflection of the second optical signal. In this regard, the angle of the receiving and turning prism 40210 is generally set to 41° to 43°.

For example, the angle of the receiving and turning prism 40210 is 42°, and the main optical axis incident on the optical reception chip 4028 is not perpendicular to the upper surface of the optical reception chip 4028, but forms an angle of 84°. In this way, a small portion of the second optical signal incident on the optical reception chip 4028 may be reflected by the optical reception chip, but this small portion of the second optical signal cannot be reflected back to the optical fiber adapter 501 along the original optical path.

The receiving and turning prism 40210 may be connected with the third lens 4027 or may not be connected with the third lens 4027. The receiving and turning prism 40210 may be connected to the third lens 4027 through a refractive index matching adhesive.

In the case that the receiving and turning prism 40210 is not connected with the third lens 4027, the second optical signal passes through the incident surface of the third lens 4027, the exit surface of the third lens 4027, the incident surface of the receiving and turning prism 40210, the reflective surface of the receiving and turning prism 40210 and the exit surface of the receiving and turning prism 40210 in sequence to the optical reception chip.

Light is reflected at an interface of two different refractive indices. When the receiving and turning prism 40210 is not connected with the third lens 4027, the second optical signal may be reflected at the exit surface of the third lens 4027, and may also be reflected at the incident surface of the receiving and turning prism 40210. However, when the receiving and turning prism 40210 and the third lens 4027 are connected through refractive index matching adhesive, with the refractive index matching adhesive, the second optical signal may not easily reflected at the exit surface of the third lens 4027, and may not easily reflected at the incident surface of the receiving and turning prism 40210, which reduces light loss of the second optical signal.

The receiving and turning prism 40210 is connected with the third lens 4027, which may not only reduce the optical loss of the second optical signal, but also reduce the occupied space in the optical module.

The optical reception chip 4028 is located right below the receiving and turning prism 40210, and is configured to convert the received second optical signal into a current signal. In some embodiments of the present disclosure, the optical reception chip 4028 is provided with a photosensitive surface, and the photosensitive surface receives the second optical signal, and the optical reception chip 4028 converts the second optical signal into a current signal.

Since the lithium niobate chip is generally large, in order to package the lithium niobate chip in an optical module of a conventional size, the lithium niobate chip 4024 is arranged at the second end of the transceiver base; while the laser chip 4021, the first sub-lens 40221, the isolator 4023, the second sub-lens 40222, the second lens 4025, the first filter 4026, the third lens 4027, the receiving and turning prism 40210 and the optical reception chip 4028 are all located at the first end of the transceiver base 4012. The first end of the transceiver base 4012 is the first end of the transceiver housing 4012, and the second end of the transceiver base 4012 is the second end of the transceiver housing 4012.

The transimpedance amplifier chip 40214 is configured to convert the current signal into a voltage signal.

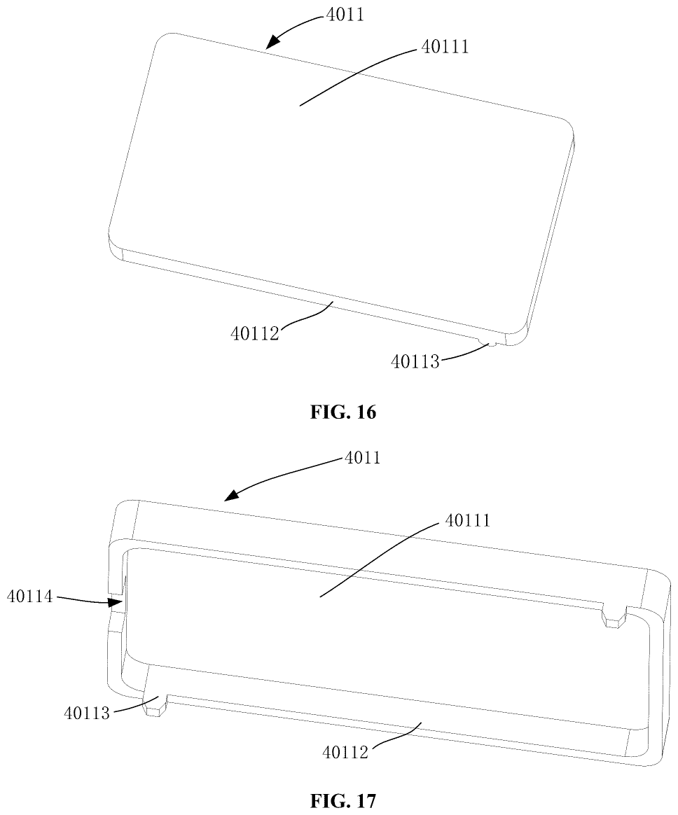

FIG. 16 is a first structural diagram of the upper cover according to some embodiments. FIG. 17 is a second structural diagram of the upper cover according to some embodiments. As shown in FIGS. 5 to 17, in some embodiments, the upper cover 4011 includes an upper cover bottom plate 40111 and an upper cover side plate 40112. The upper cover side plate 40112 is connected to the upper cover bottom plate 40111 and thus form a hollow cylinder without a cover.

The upper cover side plate 40112 is provided with an engaging groove 40114 and two positioning posts 40113. In some embodiments of the present disclosure, the upper cover side plate 40112 includes a first sub-plate, a second sub-plate, a third sub-plate and a fourth sub-plate. The first sub-plate is located at a first end of the upper cover 4011; the fourth sub-plate is located at a second end of the upper cover 4011; the second sub-plate and the third sub-plate are located between the first end and the second end of the upper cover 4011; the first sub-plate is provided with the engaging groove 40114, and the positioning posts 40113 are respectively arranged on the second sub-plate and the third sub-plate, and the two positioning posts 40113 are asymmetrical.

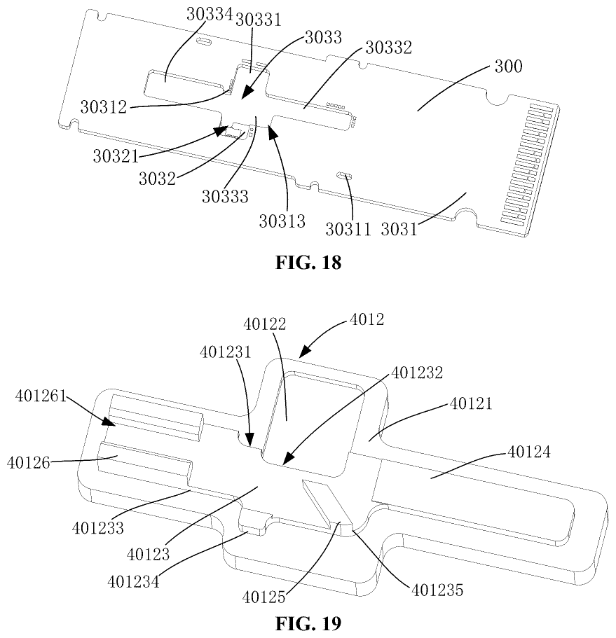

FIG. 18 is a structural diagram of a circuit board according to some embodiments. As shown in FIGS. 5 to 18, in some embodiments, the circuit board 300 includes a first sub-circuit board 3031, a second sub-circuit board 3032 and a hollowed-out area 3033. The second sub-circuit board 3032 is obtained by removing several layers of a first part of the first sub-circuit board 3031, and a second part of the first sub-circuit board 3031 which is connected with the first region is hollowed out to obtain the hollowed-out area 3033.

Since the second sub-circuit board 3032 is obtained by digging out several layers of the first sub-circuit board 3031, the second sub-circuit board 3032 is recessed relative to the first sub-circuit board 3031. That is, the second sub-circuit board 3032 is located at a lower level relative to the first sub-circuit board 3031.

The optical reception chip 4028 is arranged on the second sub-circuit board 3032. In some embodiments of the present disclosure, since the optical path of the second optical signal is turned via the receiving and turning prism, the upper surface of the optical reception chip 4028 should be lower than the upper surface of the lithium niobate chip 4024. The upper surface of the first sub-circuit board 3031 and the upper surface of the lithium niobate chip 4024 are almost at the same level, so the optical reception chip 4028 cannot be placed directly on the first sub-circuit board 3031, but is placed on the second sub-circuit board 3032 which is lower than the upper surface of the first sub-circuit board 3031.

In order to shorten a wire bonding length between the transimpedance amplifier chip 40214 and the optical reception chip 4028, and thus improve the high-frequency performance of the signal line, in some embodiments, not only the optical reception chip 4028 but also the transimpedance amplifier chip 40214 and some resistors and capacitors are arranged on the second sub-circuit board 3032.

The second sub-circuit board 3032 is further provided with a first notch 30321. The first notch 30321 is located near the optical reception chip 4028.

The hollowed-out area 3033 includes a first sub-area 30331, a second sub-area 30332, a third sub-area 30333 and a fourth sub-area 30334. The first sub-area 30331 is communicated to the third sub-area 30333. The second sub-area 30332 is located at the second end of the circuit board 300 and is communicated to the third sub-area 30333. The third sub-area 30333 is located between the first sub-area 30331 and the fourth sub-area 30334 and is communicated to the first sub-area 30331, the second sub-area 30332 and the fourth sub-area 30334, respectively. The fourth sub-area 30334 is located at the first end of the circuit board 300. One side of the third sub-area 30333 is communicated to the first sub-area 30331, and the other side of the third sub-area 30333 is arranged with the second sub-circuit board 3032.

The hollowed-out area 3033 has a cross shape.

The first sub-circuit board 3031 is provided with: a first protrusion 30312 at a junction of the first sub-area 30331 and the fourth sub-area 30334; a second protrusion at a junction of the fourth sub-area 30334 and the first notch 30321; and a first recess 30313 at a junction of the third sub-area 30333 and the second sub-area 30332. A third protrusion is provided at a junction of the first notch 30321 and the second sub-circuit board 3032.

Since the first sub-circuit board 3031 is provided with wire bonding pins, which are connected to the laser chip 4021 and thermistor in the first sub-area 30331 through wire bonding, the first protrusion 30312 is formed at the junction of the first sub-area 30331 and the fourth sub-area 30334 of the first sub-circuit board 3031.

The optical assembly is arranged in the hollowed-out area 3033. In some embodiments of the present disclosure, the laser chip 4021, the first sub-lens 40221 and the isolator 4023 are arranged in the first sub-area 30331; the lithium niobate chip 4024 is arranged in the second sub-area 30332; the second sub-lens 40222, the second lens 4025, the first filter 4026 and the third lens 4027 are arranged in the third sub-area 30333; and the fourth lens 4029 is arranged in the fourth sub-area 30334.

In addition to the hollowed-out area 3033, the first sub-circuit board 3031 is also provided with through holes 30311. The through holes 30311 are arranged corresponding to the positioning posts 40113. The positioning posts 40113 of the upper cover side plate 40112 are engaged in the through holes 30311, and the upper cover side plate 40112 and the first sub-circuit board 3031 are bonded through adhesive.

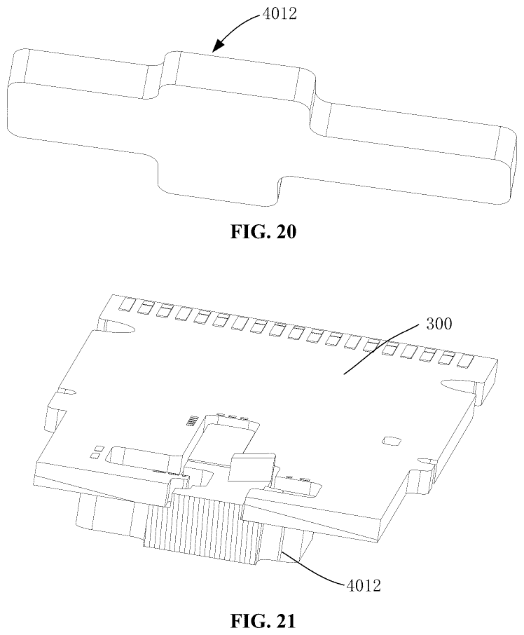

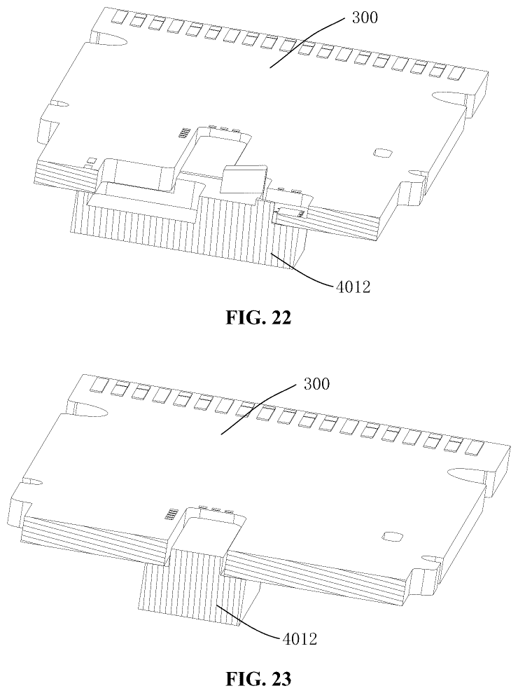

FIG. 19 is a first structural diagram of a transceiver base according to some embodiments. FIG. 20 is a second structural diagram of a transceiver base according to some embodiments. FIG. 21 is a first sectional diagram of a transceiver base and a circuit board according to some embodiments. FIG. 22 is a second sectional diagram of a transceiver base and a circuit board according to some embodiments. FIG. 23 is a third sectional diagram of a transceiver base and a circuit board according to some embodiments. As shown in FIGS. 5 to 23, in some embodiments, the transceiver base 4012 includes a base body 40121, and the base body 40121 is provided thereon with a storage groove 40122, a first support protrusion 40123, a second support protrusion 40124, a support boss 40125 and an engaging member 40126.

The transceiver base 4012 is generally made of a metal material with a thermal expansion coefficient close to that of glass, silicon and the like, and has a good thermal conductivity. The transceiver base 4012 is a metal transceiver base, which is not only configured to bond the optical assembly so as to stabilize the optical path, but also to conduct heat generated by the optical assembly to the lower shell part of the optical module in a timely manner, thereby reducing the operating temperature of the optical assembly.

The area of the base body 40121 except the storage groove 40122, the first support protrusion 40123, the second support protrusion 40124, the support boss 40125 and the engaging member 40126 is bonded to the lower surface of the circuit board 300 through adhesive. The storage groove 40122, the first support protrusion 40123, the second support protrusion 40124, the support boss 40125 and the engaging member 40126 are engaged with the hollowed-out area 3033 of the circuit board 300.

The storage groove 40122, the first support protrusion 40123, the second support protrusion 40124, the support boss 40125 and the engaging member 40126 are engaged with the hollowed-out area 3033 of the circuit board 300; and an upper surface of the first support protrusion 40123 is located at a lower level than the upper surface of the circuit board 300, such that a height difference between an upper surface of the lithium niobate chip 4024 placed on the second support protrusion 40124 and the upper surface of the circuit board 300 is as small as possible, thereby reducing a wire bonding distance between a first wire bonding pin on the lithium niobate chip 4024 and a second wire bonding pin on the circuit board 300, to thereby improving the high-frequency transmission performance of the optical module.

Length and width of an area of the base body 40121 corresponding to the storage groove 40122 are both greater than length and width of the storage groove 40122. Length and width of an area of the base body 40121 corresponding to the first support protrusion 40123 are both greater than length and width of the first support protrusion 40123. Length and width of an area of the base body 40121 corresponding to the second support protrusion 40124 are both greater than length and width of the second support protrusion 40124. Length and width of an area of the base body 40121 corresponding to the support boss 40125 are both greater than length and width of the support boss 40125. Length and width of an area of the base body 40121 corresponding to the engaging member 40126 are both greater than length and width of the engaging member 40126.

The storage groove 40122 is formed by the base body 40121 being recessed inwardly and downwardly. The first support protrusion 40123 is formed by the base body 40121 protruding inwardly and upwardly. The second support protrusion 40124, the support boss 40125 and the engaging member 40126 are all formed by the first support protrusion 40123 protruding inwardly and upwardly. The engaging member 40126 is located at a first end of the first support protrusion 40123; the second support protrusion 40124 is located at a second end of the first support protrusion 40123; the support boss 40125 and the storage groove 40122 are both located between the engaging member 40126 and the second support protrusion 40124; the storage groove 40122 is located at one side of the first support protrusion 40123 and is contiguous to the first support protrusion 40123.

The storage groove 40122 is arranged corresponding to the first sub-area 30331, and a thermo electric cooler (TEC for short) is arranged in the storage groove 40122. The second support protrusion 40124 is arranged corresponding to the second sub-area 30332, and the lithium niobate chip 4024 is arranged on the second support protrusion 40124. The first support protrusion 40123 is arranged corresponding to the third sub-area 30333 and the fourth sub-area 30334; and the second lens 4025, the second support protrusion 40124, the support boss 40125, the third lens 4027, the fourth lens 4029 and the engaging member 40126 are arranged on the first support protrusion 40123. The first filter 4026 is adhered to one side of the support boss 40125. The engaging member 40126 is provided with an engaging cavity 40261, and the optical fiber ferrule 503 is engaged in the engaging cavity 40261. The engaging cavity 40261 and the engaging groove 40114 on the upper cover 4011 form an insertion hole, and the optical fiber ferrule 503 is arranged in the insertion hole.

A thermo electric cooler (TEC for short) is disposed in the storage groove 40122. The TEC is configured to control the temperature of the laser chip 4021 such that the laser chip 4021 emits a light of a certain wavelength.

In order that an optical waveguide of the laser chip 4021 above the TEC and an optical waveguide of the lithium niobate chip 4024 are located on the same horizontal level without raising the position height of the second support protrusion 40124, in some embodiments, the TEC is placed in the storage groove 40122, and the storage groove 40122 is recessed relative to the base body 40121.

Since a thickness tolerance of the TEC is generally poorly controlled, a height difference between the optical waveguide of the laser chip 4021 and the optical waveguide of the lithium niobate chip 4024 is large, the first lens 4022 may only couple a small portion of the light of a certain wavelength emitted by the laser chip 4021 to the lithium niobate chip 4024, resulting in low coupling efficiency. To avoid this problem, in some embodiments, a first ceramic substrate is bonded to the TEC.

A second ceramic substrate is disposed on the first ceramic substrate, and the laser chip 4021 and a thermistor are disposed on the second ceramic substrate.

With the first ceramic substrate, the height difference between the optical waveguide of the laser chip 4021 and the optical waveguide of the lithium niobate chip 4024 may be reduced, and thus the optical waveguide of the laser chip 4021 and the optical waveguide of the lithium niobate chip 4024 may located in the same horizontal level as much as possible, thereby improving the coupling efficiency.

In addition to the second ceramic substrate, the first lens 4022 and the first filter 4026, the first ceramic substrate is also provided thereon with a switching circuit for connecting the TEC, the laser chip 4021 and the thermistor to the third circuit board 303.

The laser chip 4021 and the thermistor are disposed on the second ceramic substrate.

The thermistor is located near the laser chip 4021 and is configured to monitor a change of the temperature of the laser chip 4021.

In addition to the laser chip 4021 and the thermistor, the second ceramic substrate is also provided thereon with a circuit for connecting the laser chip 4021 and the thermistor to the switching circuit.

As shown in FIGS. 5 to 23, in some embodiments, the lithium niobate chip 4024 is disposed on the second support protrusion 40124; and the length and width of the second support protrusion 40124 are both greater than or equal to the length and width of the lithium niobate chip 4024. In order to shorten a wire bonding distance between a second wire bonding pin of the lithium niobate chip 4024 and a second wire bonding pin of the circuit board 300 as much as possible, in some embodiments, a width of the second sub-area 30332 is equal to the width of the lithium niobate chip 4024, and a length of the second sub-area 30332 is equal to the length of the lithium niobate chip 4024.

As shown in FIGS. 5 to 23, in some embodiments, a height of the first support protrusion 40123 is less than or equal to a height of the second support protrusion 40124. In some embodiments of the present disclosure, a thickness of the lithium niobate chip 4024 is about 500 μm, and a height of the second lens 4025 is 1 mm, that is, a height difference between a center of the second lens 4025 and a lower surface of the second lens 4025 is 500 μm. During the assembly process of the optical module, it needs to move the second lens 4025 up, down, left, or right such that the second lens 4025 can collimate as much as possible the modulated optical signal modulated by the lithium niobate chip 4024. Therefore, the height of the first support protrusion 40123 where the second lens 4025 is located is lower than the height of the second support protrusion 40124 where the lithium niobate chip 4024 is located.

Alternatively, if the thickness of the lithium niobate chip 4024 is about 550 μm, since the height difference between the center of the second lens 4025 and the lower surface of the second lens 4025 is 500 μm, the height of the first support protrusion 40123 where the second lens 4025 is located is equal to the height of the second support protrusion 40124 where the lithium niobate chip 4024 is located.

As shown in FIGS. 5 to 23, in some embodiments, the first support protrusion 40123 is further provided with a second notch 401231, a third notch 401232, a fourth protrusion 401233, a fifth protrusion 401234, and a sixth protrusion 401235.

A first side edge of the first support protrusion 40123 is recessed inward to form the second notch 401231 and the third notch 401232. The second notch 401231 is located between the engaging member 40126 and the third notch 401232. The third notch 401232 is arranged corresponding to the storage groove 40122. The second notch 401231 is communicated with the third notch 401232, and the third notch 401232 is further recessed relative to the second notch 401231.

The second notch 401231 is arranged corresponding to the first protrusion 30312, and the first protrusion 30312 is engaged with the second notch 401231.

A second side edge of the first support protrusion 40123 protrudes outward to form the fourth protrusion 401233, the fifth protrusion 401234 and the sixth protrusion 401235. Degrees at which the fourth protrusion 401233, the sixth protrusion 401235, and the fifth protrusion 401234 are protruded are successively deepened. The fourth protrusion 401233 is located at the first end of the first support protrusion 40123, the fifth protrusion 401234 is located between the fourth protrusion 401233 and the sixth protrusion 401235, and the sixth protrusion 401235 is located at the second end of the first support protrusion 40123. A junction of the fourth protrusion 401233 and the fifth protrusion 401234 is the second recess, and a junction of the fifth protrusion 401234 and the sixth protrusion 401235 is the third recess.

The fifth protrusion 401234 is configured to place the receiving and turning prism. The fifth protrusion 401234 is arranged corresponding to the first notch 30321, and the fifth protrusion 401234 is engaged with the first notch 30321. The second recess is arranged corresponding to the second protrusion, and the second protrusion is engaged with the second recess. The third recess is arranged corresponding to the third protrusion, and the third protrusion is engaged with the third recess. The first recess 30313 is arranged corresponding to the sixth protrusion 401235, and the sixth protrusion 401235 is engaged with the first recess 30313.

As shown in FIGS. 4 to 23, in some embodiments, the filter bracket is the support boss 40125, and the first filter 4026 is bonded to the side of the support boss 40125 facing the optical fiber adapter 501. The first filter 4026 is configured to transmit and couple the optical signal collimated by the second lens 4025 to the fourth lens 4029, and to reflect the second optical signal collimated by the fourth lens 4029 to the third lens 4027.

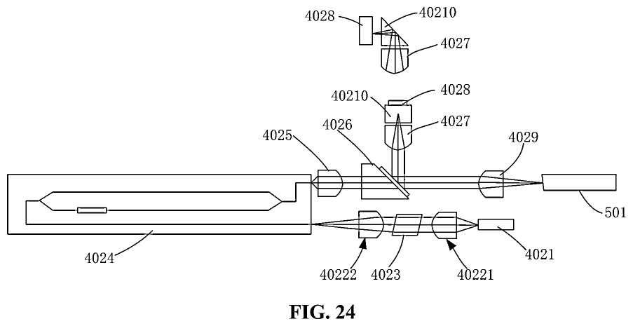

FIG. 24 is an optical path diagram of an optical module according to some embodiments. As shown in FIGS. 5 to 24, in some embodiments, the laser chip 4021 emits a light of a certain wavelength, the first sub-lens 40221 collimates the light of the certain wavelength emitted by the laser chip to obtain a collimated light, the second sub-lens 40222 couples the collimated light to the lithium niobate chip 4024, and the light of the certain wavelength is modulated by the lithium niobate chip 4024 to obtain a modulated optical signal, the modulated optical signal is collimated by the second lens 4025 to obtain a collimated optical signal, the collimated optical signal passes through the first filter 4026 and is coupled to the optical fiber ferrule 503 of the optical fiber ferrule assembly 500 through the fourth lens 4029. Among them, a light with a wavelength of λ1 is employed as the light of a certain wavelength.

As shown in FIGS. 4 to 24, in some embodiments, the optical fiber ferrule 503 of the optical fiber ferrule assembly 500 emits a second optical signal, the second optical signal is collimated by the fourth lens 4029 to obtain a collimated optical signal, the collimated optical signal is reflected by the first filter 4026 to the third lens 4027, the third lens 4027 couples the second optical signal reflected by the first filter 4026 to the receiving and turning prism 40210, and the second optical signal is changed in direction by the receiving and turning prism 40210 and is incident on the optical reception chip 4028.

The present disclosure provides an optical module including a circuit board and an optical transceiver assembly. The circuit board is provided with a hollowed-out area. The optical transceiver assembly includes a transceiver base and an optical assembly. The transceiver base is engaged with the lower surface of the circuit board. The transceiver base includes a base body and a first support protrusion protruded by the base body. The first support protrusion is engaged with the hollowed-out area, and other area of the base body other than the first support protrusion is connected to the lower surface of the circuit board. The first support protrusion is provided with a storage groove, a second support protrusion and an engaging member for engaging an optical fiber ferrule. The storage groove is located between the second support protrusion and the engaging member. The optical assembly includes a laser chip, a first lens, a lithium niobate chip, a second lens, a first filter, a third lens, a fourth lens and a receiving and turning prism. The laser chip, the first lens, the second lens, the first filter, the receiving and turning prism, the third lens and the fourth lens are all located at a first end of the first support protrusion; and the lithium niobate chip is located at a second end of the first support protrusion. The laser chip is located in the storage groove. The lithium niobate chip is located on the second support protrusion. The laser chip is a high-power DFB laser chip. The high-power DFB laser chip is configured to emit high-power light. The first lens is located between the laser chip and the lithium niobate chip, and is configured to couple the high-power light to the lithium niobate chip. The lithium niobate chip is arranged corresponding to the hollowed-out area, including a substrate and a lithium niobate film, and its optical loss is less than 10 dB, and is configured to modulate the high-power light to obtain a modulated optical signal. The lithium niobate film is laid on the substrate and has a thickness of less than 100 μm. Since the lithium niobate chip is small and has a high integration accuracy, compared with the silicon photonic chip, the lithium niobate chip has the advantages of low power consumption and low optical loss. Among them, the optical loss of the silicon photonic chip is less than 11.2 dB, while the optical loss of the lithium niobate chip is less than 10 dB. Since the optical loss of the silicon photonic chip is less than 11.2 dB, in order for an optical module including a combination of the DFB laser chip and the silicon photonic chip to meet optical power requirements of the light emitted by 50 G PON, optical power of light emitted by the DFB laser chip is required to be greater than 158 mW. Since the optical loss of the lithium niobate chip is less than 10 dB, in order to make the optical module including the DFB laser chip and the lithium niobate chip meet the optical power requirement of light emitted by 50 G PON, optical power of light emitted by the DFB laser chip is required to be greater than 80 mW. The optical power of light emitted by a conventional DFB laser chip is less than 50 mW, and optical power of light emitted by high-power DFB laser chip is less than 120 mW. In view of current technical level, it is difficult for the optical power of the light emitted by the DFB laser chip to meet the optical power requirement of more than 120 mW under full temperature. Therefore, in order for the optical module to meet the optical power requirement of light emitted by 50 G PON, the optical module can only adopt the combination of DFB laser chip and lithium niobate chip. The second lens is located between the lithium niobate chip and the first filter, and is configured to collimate the modulated optical signal to obtain a collimated optical signal. The first filter is located between the laser chip and the fourth lens, and is configured to transmit the collimated optical signal to the optical fiber ferrule. The third lens is located between the optical fiber ferrule and the first filter, and is configured to couple the first optical signal transmitted by the first filter to the optical fiber ferrule, and also collimate the second optical signal emitted by the optical fiber ferrule and then transmit it into the first filter. The fourth lens is located between the first filter and the receiving and turning prism, and is configured to couple the second optical signal reflected by the first filter to the receiving and turning prism. The receiving and turning prism is located above the optical reception chip, and is configured to change the direction of the second optical signal such that the second optical signal is reflected to the optical reception chip. In the present disclosure, the laser chip provides a high-power light, and the optical loss of the lithium niobate chip is less than the optical loss of the silicon photonic chip, so that the modulated optical signal modulated by the lithium niobate chip meets the optical power requirement of light emitted by the 50 G PON.

Finally, it should be noted that the above embodiments are only used to illustrate the technical solutions of the present disclosure, rather than to limit them. Although the present disclosure has been described in detail with reference to the aforementioned embodiments, those skilled in the art should understand that they can still modify the technical solutions described in the aforementioned embodiments, or make equivalent replacements for some of the technical features therein. However, these modifications or replacements do not deviate the essence of the corresponding technical solutions from the spirit and scopes of the technical solutions of the embodiments of the present disclosure.

1. An optical module, comprising:
a circuit board having a hollowed-out area;
an optical transceiver assembly comprising a transceiver base and an optical assembly, wherein
the transceiver base comprises a base body and a first support protrusion protruded by the base body, and wherein the base body is provided thereon with a storage groove and a second support protrusion; and the first support protrusion, the second support protrusion and the storage groove are all engaged in the hollowed-out area;
the optical assembly comprises a laser chip and a lithium niobate chip; and wherein the laser chip is located at a first end of the first support protrusion, and the lithium niobate chip is located at a second end of the first support protrusion; the laser chip is located in the storage groove, and the lithium niobate chip is located on the second support protrusion.

2. The optical module according to claim 1, wherein the optical assembly further comprises a first lens, a second lens, a first filter, a third lens, a fourth lens and a receiving and turning prism, wherein
the first lens, the second lens, the first filter, the third lens, the fourth lens and the receiving and turning prism are all located at the first end of the first support protrusion.

3. The optical module according to claim 2, further comprising an optical fiber ferrule, and the first support protrusion is further provided thereon with an engaging member, and wherein the storage groove is located between the second support protrusion and the engaging member, and the optical fiber ferrule is engaged in the engaging member.

4. The optical module according to claim 3, wherein the hollowed-out area comprises a first sub-area, a second sub-area, a third sub-area and a fourth sub-area, wherein
the first sub-area is connected to the third sub-area, and is arranged corresponding to the storage groove;
the second sub-area is located at a second end of the circuit board, is communicated to the third sub-area, and is arranged corresponding to the second support protrusion;
the third sub-area is located between the first sub-area and the fourth sub-area, and is communicated to the first sub-area, the second sub-area and the fourth sub-area, respectively; and
the fourth sub-area is located at a first end of the circuit board and is arranged corresponding to the engaging member.

5. The optical module according to claim 4, wherein the hollowed-out area has a cross shape.

6. The optical module according to claim 4, wherein the first lens comprises a first sub-lens and a second sub-lens, and wherein the first sub-lens is a collimating lens configured for collimating a divergent light into a collimated light, and the second sub-lens is a focusing lens configured for focusing the collimated light and coupling it into the lithium niobate chip;
the laser chip and the first sub-lens are arranged in the first sub-area; the lithium niobate chip is arranged in the second sub-area; the second sub-lens, the second lens, the first filter and the third lens are arranged in the third sub-area; and the fourth lens is arranged in the fourth sub-area.

7. The optical module according to claim 4, wherein the circuit board comprises a first sub-circuit board and a second sub-circuit board, wherein
the first sub-circuit board is provided with the hollowed-out area and a through hole;
the second sub-circuit board is connected with the first sub-circuit board, and is recessed relative to the first sub-circuit board; and the second sub-circuit board is configured for arranging an optical reception chip.

8. The optical module according to claim 7, further comprising a transimpedance amplifier chip, wherein the transimpedance amplifier chip is wire-bonded to the optical reception chip, and the transimpedance amplifier chip is configured to convert a current signal into a voltage signal; and
the transimpedance amplifier chip is arranged on the second sub-circuit board.

9. The optical module according to claim 7, wherein the optical transceiver assembly further comprises an upper cover, wherein the upper cover is disposed on the circuit board, the upper cover and the transceiver base form a transceiver cavity, and the optical assembly is located in the transceiver cavity.

10. The optical module according to claim 9, wherein the upper cover comprises an upper cover bottom plate and an upper cover side plate, wherein
the upper cover side plate is connected to the upper cover bottom plate, and is provided with an engaging groove and a positioning post;
the engaging groove is located at a first end of the upper cover side plate and is arranged corresponding to the engaging member, and the engaging groove cooperates with the engaging member to allow the optical fiber ferrule to be inserted;
the positioning post is arranged corresponding to the through hole and is engaged with the through hole.

11. The optical module according to claim 9, wherein a width of the upper cover is greater than a width of the hollowed-out area, and a width of the transceiver base is greater than the width of the hollowed-out area.

12. The optical module according to claim 4, further comprising an optical fiber ferrule assembly;
the optical fiber ferrule assembly comprises an optical fiber adapter, an internal optical fiber and the optical fiber ferrule;
a first end of the internal optical fiber is connected to the optical fiber adapter, and a second end of the internal optical fiber is connected to a first end of the optical fiber ferrule;
the optical fiber ferrule is located in the fourth sub-area, and a second end of the optical fiber ferrule is engaged with the engaging member.

13. The optical module according to claim 4, wherein the first support protrusion is provided with a second notch, a third notch, a fourth protrusion, a fifth protrusion, and a sixth protrusion, wherein
the third notch and the second notch are both located at a first side edge of the first support protrusion; the third notch is arranged corresponding to the storage groove, is communicated to the second notch, and is further recessed relative to the second notch;
the fourth protrusion is located at the first end of the first support protrusion; and the fourth protrusion, the fifth protrusion and the sixth protrusion are located at a second side edge of the first support protrusion;
the fifth protrusion is located between the fourth protrusion and the sixth protrusion, and the receiving and turning prism is disposed on the fifth protrusion;
the sixth protrusion is located at the second end of the first support protrusion; and
degrees at which the fourth protrusion, the sixth protrusion and the fifth protrusion are protruded are successively increased.

14. The optical module according to claim 13, further comprising a first sub-circuit board and as second sub-circuit board; wherein the second sub-circuit board is provided with a first notch; the first sub-circuit board is provided with a first recess at a junction of the third sub-area and the second sub-area; the first sub-circuit board is provided with a second protrusion at a junction of the fourth sub-area and the first notch; and a third protrusion is provided at a junction of the first notch and the second sub-circuit board;
the fifth protrusion is configured for placing the receiving and turning prism, and the fifth protrusion is engaged in the first notch; a second recess is formed at a junction of the fourth protrusion and the fifth protrusion, and the second protrusion is engaged in the second recess; a third recess is formed at a junction of the fifth protrusion and the sixth protrusion, and the third protrusion is engaged in the third recess; and the sixth protrusion is engaged in the first recess.

15. The optical module according to claim 13, further comprising a first sub-circuit board and a second sub-circuit board; wherein the first sub-circuit board is provided with a first protrusion at a junction of the first sub-area and the fourth sub-area, and the first protrusion is engaged with the second notch.

16. The optical module according to claim 2, wherein the base body is further provided thereon with a support boss, wherein the support boss is engaged in the hollowed-out area, and the first filter is arranged on the support boss.

17. The optical module according to claim 2, wherein the first filter comprises two 45-degree triangular prisms, wherein hypotenuses of the two 45-degree triangular prisms are bonded to each other, and one of the hypotenuses is coated with a filter film; or
the first filter comprises a glass sheet, wherein one end of the glass sheet facing an internal optical fiber is coated with a filter film.

18. The optical module according to claim 2, wherein the receiving and turning prism is connected with or not connected with the third lens, and wherein an angle of the receiving and turning prism is 41° to 43°.

19. The optical module according to claim 1, wherein a height of the first support protrusion is less than or equal to a height of the second support protrusion.

20. The optical module according to claim 1, wherein the lithium niobate chip comprises a substrate and a lithium niobate film, wherein an optical loss of the lithium niobate chip is less than 10 dB; the lithium niobate film is laid on the substrate, and has a thickness less than 100 μm; and an input port and an output port of the lithium niobate chip are located on a same side of the lithium niobate chip.
